(19) United States
(12) Patent Application Publication
(10) Pub. No.: US 2026/0351786 A1
(43) Pub. Date: Nov. 5, 2026

(54) EXPANSION CHAMBER FOR BATTERY SYSTEMS

(71) Applicant: GM Global Technology Operations LLC, Detroit, MI (US)

(72) Inventors: Chinmaya Patil, South Lyon, MI (US); Derek Frei Lahr, Ann Arbor, MI (US); Xiaoling Chen, Sterling Heights, MI (US); Simon James Hammond Trask, Royal Oak, MI (US); Sean Michael Welch, Bruce Twp, MI (US); Teresa U. Holiness-Stalling, Detroit, MI (US)

(73) Assignee: GM Global Technology Operations LLC, Detroit, MI (US)

(21) Appl. No.: 19/196,515

(22) Filed: May 1, 2025

(51) Int. Cl. H01M 50/367; B60L 50/64; H01M 10/625; H01M 10/6551; H01M 10/658; H01M 50/249

(52) U.S. Cl. CPC H01M 50/367; B60L 50/64; H01M 10/625; H01M 10/6551; H01M 10/658; H01M 50/249; H01M 2220/20

(57) ABSTRACT

A battery pack including a cell holder having one or more slots, one or more battery cells arranged in the cell holder, a thermal barrier layer coupled to the cell holder and covering the one or more battery cells and the one or more slots, a first chamber adjacent to the thermal barrier layer and coupled to the cell holder, the first chamber including one or more first outlets; and a second chamber corresponding to the first chamber and coupled to the cell holder, the second chamber including one or more second outlets spaced from the first outlets of the first chamber.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to battery systems and, more particularly, to a thermal propagation system for battery modules and battery packs.

Battery systems are widely used in various applications, including electric vehicles, portable electronic devices, and energy storage systems. These systems often incorporate mechanisms to help manage thermal propagation events. Various systems and methods have been developed to address the challenges associated with thermal propagation scenarios. Shortcomings of the existing systems and methods are addressed by one or more aspects of the present disclosure.

### SUMMARY

In one configuration, a battery pack is provided and includes a cell holder having one or more slots, one or more battery cells arranged in the cell holder, a thermal barrier layer coupled to the cell holder and covering the one or more battery cells and the one or more slots, a first chamber adjacent to the thermal barrier layer and coupled to the cell holder, the first chamber including one or more first outlets, and a second chamber corresponding to the first chamber and coupled to the cell holder, the second chamber including one or more second outlets spaced from the first outlets of the first chamber.

The battery pack may include one or more of the following optional aspects. For example, the battery pack can include a first fluid conduit disposed between the first chamber and the thermal barrier layer. The first fluid conduit can extend between the one or more slots and the one or more first outlets of the first chamber. The battery pack can include a second fluid conduit disposed between the first chamber and the second chamber. The second fluid conduit can extend between the one or more first outlets of the first chamber and the one or more second outlets of the second chamber.

According to at least one aspect, the first chamber includes a first serpentine channel and the second chamber can include a second serpentine channel that corresponds with the first serpentine channel. The first chamber can include a first serpentine pathway along the first serpentine channel and extending from the one or more battery cells to the one or more first outlets of the first chamber. The second chamber can include a second serpentine pathway along the second serpentine channel and extending from the one or more first outlets of the first chamber to the one or more second outlets of the second chamber. The second serpentine channel can include staggered fins extending into the second serpentine pathway toward the first chamber. The second serpentine channel can include ribs extending into the second serpentine pathway toward the first chamber.

In another configuration, a vehicle is provided and includes a vehicle body extending between a first end and a second end, an electric motor coupled to the vehicle body, and a battery pack coupled to the vehicle body and communicatively coupled to the electric motor. The battery pack including a cell holder including one or more slots, one or more battery cells arranged in the one or more slots, a thermal barrier layer coupled to the cell holder and covering the one or more battery cells and the one or more slots, a first chamber adjacent to the thermal barrier layer and coupled to the cell holder, the first chamber including one or more first outlets, and a second chamber corresponding to the first chamber and coupled to the cell holder, the second chamber including one or more second outlets spaced from the first outlets of the first chamber.

The vehicle may include one or more of the following optional aspects. For example, the battery pack can include a first fluid conduit disposed between the first chamber and the thermal barrier layer. The first fluid conduit can extend between the one or more slots and the one or more first outlets of the first chamber. The battery pack can include a second fluid conduit disposed between the first chamber and the second chamber. The second fluid conduit can extend between one or more first openings and the one or more second outlets of the second chamber.

According to at least one aspect, the first chamber can include a first serpentine channel and the second chamber can include a second serpentine channel that corresponds with the first serpentine channel. The first chamber can include a first serpentine pathway along the first serpentine channel and can extend from the one or more battery cells to the one or more first outlets of the first chamber. The second chamber can include a second serpentine pathway along the second serpentine channel and can extend from the one or more first outlets of the first chamber to the one or more second outlets of the second chamber. The second serpentine channel can include staggered fins extending into the second serpentine pathway toward the first chamber. The second serpentine channel can include ribs extending into the second serpentine pathway toward the first chamber.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle according to principles of the present disclosure;

FIG. 2 is a partial exploded view of a battery pack having an expansion chamber;

FIG. 3A is a fragmentary cross-sectional view of the expansion chamber of FIG. 2;

FIG. 3B is a bottom view of a channel of one configuration of an outer chamber of the expansion chamber of FIG. 3A;

FIG. 3C is a bottom view of a channel of another configuration of an outer chamber of the expansion chamber of FIG. 3A;

FIG. 4A is a partial exploded view of a battery pack having an expansion chamber;

FIG. 4B is a cross-sectional view of the battery pack of FIG. 4A;

FIG. 5A is a top partial exploded view of a battery pack having an expansion chamber; and

FIG. 5B is a bottom partial exploded view of the battery pack of FIG. 5A.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Electric vehicles can be equipped with a battery pack that includes one or more battery cells. Lithium-ion batteries are typically used in vehicles due to their high energy and power densities. Sometimes, however, a chain of uncontrolled exothermic reactions can occur within the lithium-ion batteries (i.e., thermal propagation). These reactions can result in a rise in internal temperature of the battery that causes inner structures of the battery to destabilize and degrade and eventually lead to failure of the battery and/or damage to the vehicle. Managing flow of gases and particulate matter from one or more unstable battery cells is desirable for mitigating damage to neighboring battery cells and/or the vehicle where the cells are located.

As introduced in more detail below, a rechargeable energy storage system (RESS) or battery modules can be equipped with an expansion chamber that enables expansion and cooling of gases and particulate matter that results during a thermal propagation event. The expansion chamber can include a dual chamber design that defines a pathway that allows gases and/or particulate matter to dissipate and cool before exiting the expansion chamber.

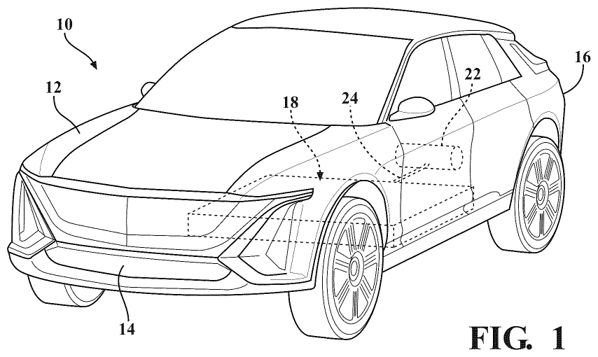

With reference to FIG. 1, an illustrative example of a vehicle 10 is provided. The vehicle 10 has a vehicle body 12 extending between a first end 14 and a second end 16. The vehicle 10 includes a battery pack 18 coupled to the vehicle body 12. The battery pack 18 includes one or more battery cells communicatively coupled to one another. In the present illustrative example, the battery cells can be cylindrical battery cells, prismatic battery cells, or another cell design used in the automotive industry. The battery pack 18 is communicatively coupled to an electric motor 22 that is coupled to the vehicle body 12 via a cable 24.

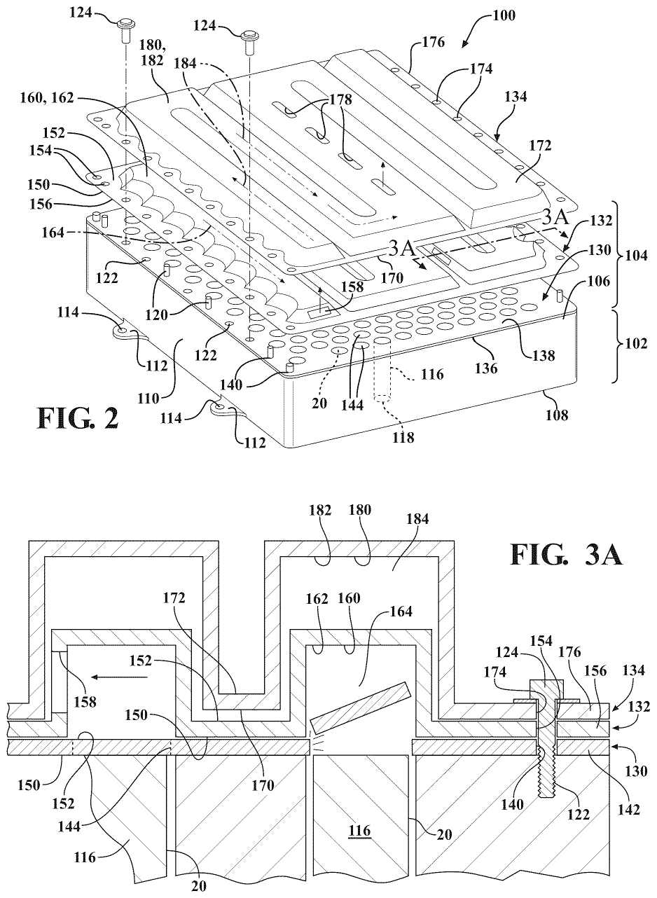

With reference to FIG. 2, an illustrative example of a battery pack 100 having a cell holder 102 and an expansion chamber 104 is provided. The cell holder 102 includes a first side 106 and a second side 108 spaced from the first side 106. The cell holder 102 has a perimeter wall 110 extending between the first side 106 and the second side 108 and including one or more mounting flanges 112 that are configured to facilitate coupling or otherwise attaching the battery pack 100 to a vehicle (e.g., the vehicle 10). The mounting flanges 112 can have openings 114 that are configured to receive a fastener (not shown), for example. The cell holder 102 can be configured to receive one or more battery modules (not shown) and/or one or more battery cells 116. For instance, the cell holder 102 can include a potting structure (e.g., a honeycomb holder) that has one or more slots 118 that extend between the first side 106 and the second side 108 and are configured to receive the one or more battery cells 116. The battery cells 116 are cylindrical battery cells in the present example, however, the principles of the present disclosure equally apply to battery cells that have another shape (e.g., prismatic battery cells). According to one aspect, the slots 118 can be arranged so that the battery cells 116 are positioned in rows or columns that correspond with the expansion chamber 104. The battery cells 116 are communicatively coupled to one another using bus bars (not shown) or another manner used in the automotive industry.

With continued reference to FIG. 2, one or more alignment pins 120 are coupled to the cell holder 102 and extend away from the first side 106. The one or more alignment pins 120 are configured to receive and position the expansion chamber 104 with respect to the cell holder 102. The cell holder 102 also includes one or more holes 122 that are configured to receive one or more fasteners 124 for securing the expansion chamber 104 to the cell holder 102.

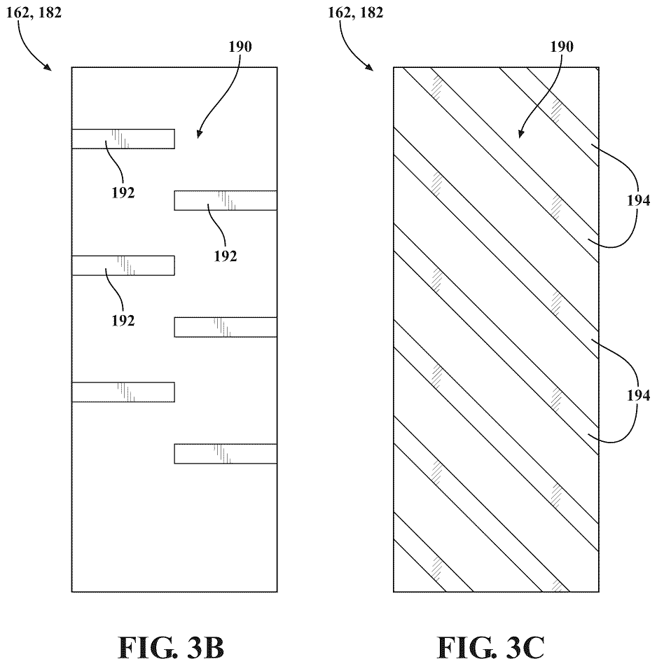

The expansion chamber 104 includes a thermal barrier layer 130, a first or inner chamber 132, and a second or outer chamber 134. With reference to FIGS. 2 and 3A, the thermal barrier layer 130 is coupled to the cell holder 102. More particularly, the thermal barrier layer 130 includes a bottom side 136 that is coupled to or otherwise attached to the first side 106 of the cell holder 102 and covers one or more of the slots 118. The thermal barrier layer 130 includes a top side 138 that is disposed on a side opposite of the bottom side 136 and away from the first side 106 of the cell holder 102.

The thermal barrier layer 130 includes one or more fastener through holes 140 arranged adjacent to a perimeter 142 of the thermal barrier layer 130. The fastener through holes 140 are configured to correspond with the one or more alignment pins 120 and are desirable for positioning the thermal barrier layer 130 with respect to the cell holder 102. At least some of the fastener through holes 140 correspond with the holes 122 of the cell holder 102 and are configured to receive the fasteners 124 for securing the thermal barrier layer 130 to the cell holder 102. According to one aspect, the thermal barrier layer 130 can be formed of a mica material or another insulative material used in the automotive industry. Optionally, the thermal barrier layer 130 can have perforations 144 that extend between the bottom side 136 and the top side 138 and are arranged to correspond with the shape of the battery cells 116 and/or slots 118. The perforations 144 can be configured so that a portion of the thermal barrier layer 130 corresponding with one or more battery cells 116 undergoing thermal propagation can easily separate to allow gases and particulate matter to flow by the thermal barrier layer 130 and into the inner chamber 132, for example. The perforations 144 ensure that surrounding regions of the thermal barrier layer 130 remain undisturbed so that the thermal barrier layer 130 can operate to protect neighboring battery cells 116 from gases and particulate matter exiting the one or more battery cells 116 undergoing thermal propagation.

The inner chamber 132 is coupled to the cell holder 102 and, more particularly, to the first side 106 of the cell holder 102 and the thermal barrier layer 130. The inner chamber 132 includes a first side 150 and a second side 152 disposed on a side opposite of the first side 150. The first side 150 contacts and faces the top side 138 of the thermal barrier layer 130. The inner chamber 132 includes one or more fastener through holes 154 arranged adjacent to a perimeter 156 of the inner chamber 132. The fastener through holes 154 are configured to correspond with the one or more alignment pins 120 and are desirable for positioning the inner chamber 132 with respect to the cell holder 102 and the thermal barrier layer 130. At least some of the fastener through holes 154 correspond with the holes 122 of the cell holder 102 and are configured to receive the fasteners 124 for securing the inner chamber 132 to the cell holder 102. According to one aspect, the inner chamber 132 includes one or more first outlets 158 extending through the first side 150 and the second side 152. The first outlets 158 are configured to allow gasses and particulate matter to escape a first fluid conduit 160 arranged between the top side 138 of the thermal barrier layer 130 and the first side 150 of the inner chamber 132. According to one aspect, the inner chamber 132 can be formed (e.g., stamped) to include a first serpentine channel 162. In doing so, the first fluid conduit 160 includes a first serpentine pathway 164 between the battery cells 116 and/or slots 118 and the one or more first outlets 158. The first serpentine channel 162 guides gases and particulate matter along the first serpentine pathway 164 and allows the inner chamber 132 to act as a heat sink to remove heat from the gases and particulate matter. As shown in FIG. 3A, portions of the first serpentine channel 162 are arranged between rows of the battery cells 116 and, thus, the first serpentine channel 162 does not block gases and particulate matter from flowing into and along the first serpentine pathway 164. In some implementations, the inner chamber 132, or at least a portion of the inner chamber 132, is formed of a non-ferrous material. This may be desirable to reduce the weight of the expansion chamber 104, for example.

With continued reference to FIGS. 2 and 3A, the outer chamber 134 is coupled to the cell holder 102. More particularly, the outer chamber 134 includes a first side 170 that faces and contacts the second side 152 of the inner chamber 132. The outer chamber 134 has a second side 172 disposed on a side opposite of the first side 170. The outer chamber 134 includes one or more fastener through holes 174 arranged adjacent to a perimeter 176 of the outer chamber 134. The fastener through holes 174 are configured to correspond with the one or more alignment pins 120 and are desirable for positioning the outer chamber 134 with respect to the inner chamber 132. At least some of the fastener through holes 174 of the outer chamber 134 correspond with the holes 122 of the cell holder 102, the fastener through holes 140 of the thermal barrier layer 130, and the fastener through holes 154 of the inner chamber 132. A seal is formed adjacent and along the perimeters 142, 156, 176 when the fasteners 124 are inserted through the fastener through holes 140, 154, 174 and secured within the holes 122 of the cell holder 102. The seal formed between the cell holder 102 and the expansion chamber 104 and between the thermal barrier layer 130, the inner chamber 132, and the outer chamber 134 prevents gases and particulate matter from prematurely escaping the expansion chamber 104 during a thermal propagation event, for example. According to one aspect, the outer chamber 134 includes one or more second outlets 178 extending through the first side 170 and the second side 172. The second outlets 178 are configured to allow gasses and particulate matter to escape a second fluid conduit 180 arranged between the second side 152 of the inner chamber 132 and the first side 170 of the outer chamber 134. According to one aspect, the outer chamber 134 can be formed (e.g., stamped) to include a second serpentine channel 182 that generally corresponds with the shape of the first serpentine channel 162. In doing so, the second fluid conduit 180 includes a second serpentine pathway 184 between the first outlets 158 of the inner chamber 132 and the second outlets 178 of the outer chamber 134. The second serpentine channel 182 guides gases and particulate matter along the second serpentine pathway 184 and allows the outer chamber 134 to act as a heat sink to remove heat from the gases and particulate matter. In some implementations, the outer chamber 134 can be formed of a material with a high thermal conductivity, such as an aluminum alloy or copper alloy.

With reference to FIGS. 3B and 3C, a portion of the first serpentine channel 162 or the second serpentine channel 182 provides a thermal interface for removing heat from gases and particulate matter exiting one of the battery cells 116. In at least some implementations, a portion of the first serpentine channel 162 and/or a portion of the second serpentine channel 182 can include one or more projections 190 that increase surface area to enhance heat dissipation. With reference to FIG. 3B, the first serpentine channel 162 and/or the second serpentine channel 182 can include one or more fins 192 that can be formed (i.e., stamped) or otherwise arranged in the channels 162, 182. The fins 192 can be staggered along the channels 162, 182, as shown in the FIG. 3C. Staggering the fins 192 can increase turbulence within the channels 162, 182 and, thus, improve heat transfer to the inner chamber 132 and/or the outer chamber 134. With reference to FIG. 3B, the first serpentine channel 162 and/or the second serpentine channel 182 can include one or more ribs 194 that can be formed (i.e., stamped) or otherwise arranged in the channels 162, 182.

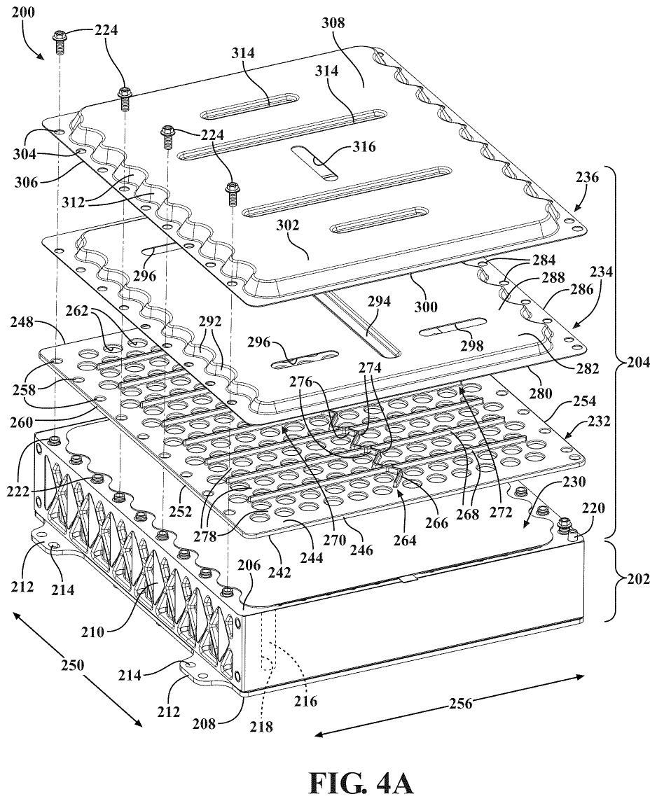

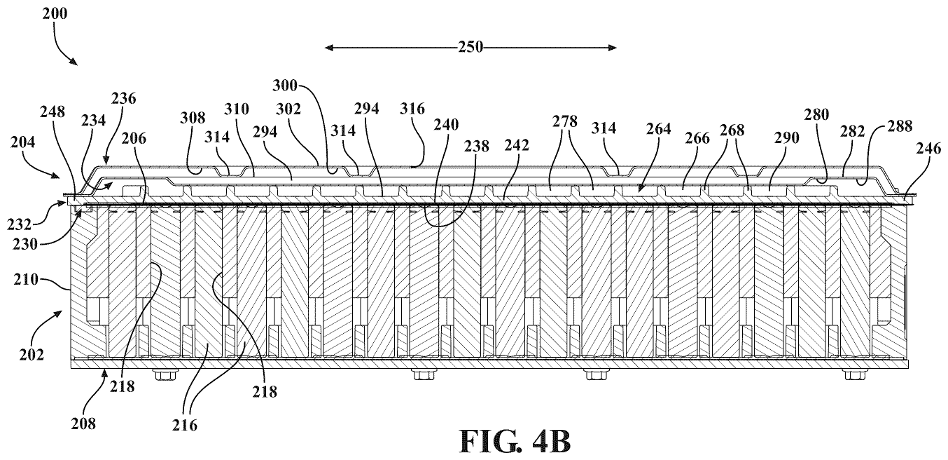

FIGS. 4A-4B illustrate another illustrative configuration of a battery pack 200. This configuration is similar in many respects to the configurations of FIG. 1 and FIGS. 2-3C. Accordingly, the descriptions of the configurations are hereby incorporated into one another, and description of subject matter common to the configurations generally may not be repeated.

With reference to FIG. 4A, an illustrative example of the battery pack 200 having a cell holder 202 and an expansion chamber 204 is provided. The cell holder 202 includes a first side 206 and a second side 208 spaced from the first side 206. The cell holder 202 has a perimeter wall 210 extending between the first side 206 and the second side 208 and including one or more mounting flanges 212 that are configured to facilitate coupling or otherwise attaching the battery pack 200 to a vehicle (e.g., the vehicle 10). The mounting flanges 212 can have openings 214 that are configured to receive a fastener (not shown), for example. The cell holder 202 can be configured to receive one or more battery modules (not shown) and/or one or more battery cells 216. For instance, the cell holder 202 can include a potting structure (e.g., a honeycomb holder) that has one or more slots 218 that extend between the first side 206 and the second side 208 and are configured to receive the one or more battery cells 216. The battery cells 216 are cylindrical battery cells in the present example, however, the principles of the present disclosure equally apply to battery cells that have another shape (e.g., prismatic battery cells). According to one aspect, the slots 218 can be arranged so that the battery cells 216 are positioned in rows or columns that correspond with the expansion chamber 204. The battery cells 216 are communicatively coupled to one another using bus bars (not shown) or another manner used in the automotive industry.

With continued reference to FIG. 4A, one or more alignment pins 220 are coupled to the cell holder 202 and extend away from the first side 206. The one or more alignment pins 220 are configured to receive and position the expansion chamber 204 with respect to the cell holder 202. The cell holder 202 also includes one or more holes 222 that are configured to receive one or more fasteners 224 for securing the expansion chamber 204 to the cell holder 202.

The expansion chamber 204 includes a thermal barrier layer 230, a thermal barrier plate 232, a first or inner chamber 234, and a second or outer chamber 236. With reference to FIGS. 4A and 4B, the thermal barrier layer 230 is coupled to the cell holder 202. More particularly, the thermal barrier layer 230 includes a bottom side 238 that is coupled to or otherwise attached to the first side 206 of the cell holder 202 and covers one or more of the slots 218. The thermal barrier layer 230 includes a top side 240 that is disposed on a side opposite of the bottom side 238 and away from the first side 206 of the cell holder 202. According to one aspect, the thermal barrier layer 230 can be formed of a mica material or another insulative material used in the automotive industry.

With continued reference to FIGS. 4A and 4B, the thermal barrier plate 232 is coupled to the cell holder 202 and sandwiches the thermal barrier layer 230 between a lower side 242 and the cell holder 202. The lower side 242 faces and contacts the first side 206 of the cell holder 202 and the top side 240 of the thermal barrier layer 230. The thermal barrier plate 232 includes an upper side 244 disposed on a side opposite of the lower side 242 and faces away from the first side 206 of the cell holder 202. The thermal barrier plate 232 extends between a first end 246 and a second end 248 spaced from the first end 246 with respect to a longitudinal direction 250 and between a first side 252 and a second side 254 spaced from the first side 252 with respect to a lateral direction 256. The thermal barrier plate 232 includes one or more fastener through holes 258 arranged adjacent to a perimeter 260 of the thermal barrier plate 232. The fastener through holes 258 are configured to correspond with the one or more alignment pins 220 and are desirable for positioning the thermal barrier plate 232 with respect to the cell holder 202 and the thermal barrier layer 230. At least some of the fastener through holes 258 correspond with the holes 222 of the cell holder 202 and are configured to receive the fasteners 224 for securing the thermal barrier plate 232 to the cell holder 202.

With reference to FIG. 4A, the thermal barrier plate 232 includes one or more openings 262 extending through the lower side 242 and the upper side 244 and correspond with the one or more slots 218. The thermal barrier plate 232 further includes a flow guide 264 coupled to and extending away from the upper side 244. The flow guide 264 includes a central spine 266 and one or more dividers 268 that are configured to direct flow of gases and particulate matter within the expansion chamber 204. The central spine 266 is coupled to the upper side 244 and divides the thermal barrier plate 232 into a first flow region 270 and a second flow region 272 with respect to the lateral direction 256. According to one aspect, the central spine 266 can include one or more peaks 274 and one or more valleys 276 that are configured to induce turbulence within the expansion chamber 204. The central spine 266 and, more particularly, the peaks and valleys 274, 276, also provide support for a portion of the inner chamber 234. The one or more dividers 268 are coupled to upper side 244 and extend transverse to the central spine 266 between the first side 252 and the second side 254 of the thermal barrier plate 232. The central spine 266 and the dividers 268 define one or more compartments 278 within the first flow region 270 and the second flow region 272. The compartments 278 can be desirable to interrupt flow and/or enhance cooling of gases and particulate matter during a thermal propagation event, for example.

The inner chamber 234 is coupled to the upper side 244 of the thermal barrier plate 232. The inner chamber 234 includes a lower side 280 and an upper side 282 disposed on a side opposite of the lower side 280. The lower side 280 contacts and faces the upper side 244 of the thermal barrier plate 232. The inner chamber 234 includes one or more fastener through holes 284 arranged adjacent to a perimeter 286 of the inner chamber 234. The fastener through holes 284 are configured to correspond with the one or more alignment pins 220 and are desirable for positioning the inner chamber 234 with respect to the cell holder 202 and the thermal barrier plate 232. At least some of the fastener through holes 284 correspond with the holes 222 of the cell holder 202 and are configured to receive the fasteners 224 for securing the inner chamber 234 to the cell holder 202.

With reference to FIGS. 4A and 4B, the lower side 280 includes a first cavity 288 that corresponds with the thermal barrier plate 232 and defines a first fluid conduit 290. Optionally, the first cavity 288 can be formed (e.g., stamped) with undulating side walls 292 that correspond with the one or more compartments 278 of the thermal barrier plate 232. The undulating side walls 292 can be desirable for increasing turbulence within the first fluid conduit 290 and enhancing cooling of gases and particulate matter during a thermal propagation event. According to another aspect, the first cavity 288 can be formed with a depression 294 that extends along and engages the central spine 266. In other words, the depression 294 further defines the first flow region 270 and the second flow region 272 within the first fluid conduit 290. The inner chamber 234 and, more particularly, the first cavity 288 includes one or more outlets extending through the lower side 280 and the upper side 282. In the present illustrative configuration, gas and particulate matter originating from a battery cell 216 arranged adjacent to the first flow region 270 can flow in and out of the one or more compartments 278 and exit through one or more of the first outlets 296. Similarly, gas and particulate matter originating from a battery cell 216 arranged adjacent to the second flow region 272 can flow in and out of the one or more compartments 278 and exit through one or more of the second outlets 298.

With continued reference to FIGS. 4A and 4B, the outer chamber 236 is coupled to the upper side 282 of the inner chamber 234. The outer chamber 236 includes a lower side 300 and an upper side 302 disposed on a side opposite of the lower side 300. The lower side 300 contacts and faces the upper side 282 of the inner chamber 234. The outer chamber 236 includes one or more fastener through holes 304 arranged adjacent to a perimeter 306 of the outer chamber 236. The fastener through holes 304 are configured to correspond with the one or more alignment pins 220 and are desirable for positioning the outer chamber 236 with respect to the cell holder 202, the thermal barrier plate 232, and the inner chamber 234. At least some of the fastener through holes 304 correspond with the holes 222 of the cell holder 202 and are configured to receive the fasteners 224 for securing the outer chamber 236 to the cell holder 202.

The lower side 300 of the outer chamber 236 includes a second cavity 308 that corresponds with the inner chamber 234 and defines a second fluid conduit 310. Optionally, the second cavity 308 can be formed (e.g., stamped) with undulating side walls 312 that correspond with the undulating side walls 292 of the first cavity 288 of the inner chamber 234. According to another aspect, the second cavity 308 can be formed with one or more depressions 314 that extend transverse to the depression 294 of the first cavity 288 and extend into the second cavity 308. In some implementations, the one or more depressions 314 can engage the upper side 282 of the inner chamber 234. The one or more depressions 314 of the second cavity 308 interrupt flow patterns of gases and particulate matter within the second fluid conduit 310 during a thermal propagation event and provide a thermal interface with which the gases and particulate matter engage. The outer chamber 236 and, more particularly, the second cavity 308 includes one or more outlets 316 extending through the lower side 300 and the upper side 302. The second fluid conduit 310 extends between the first and second outlets 296, 298 of the inner chamber 234 the one or more outlets 316 of the outer chamber 236.

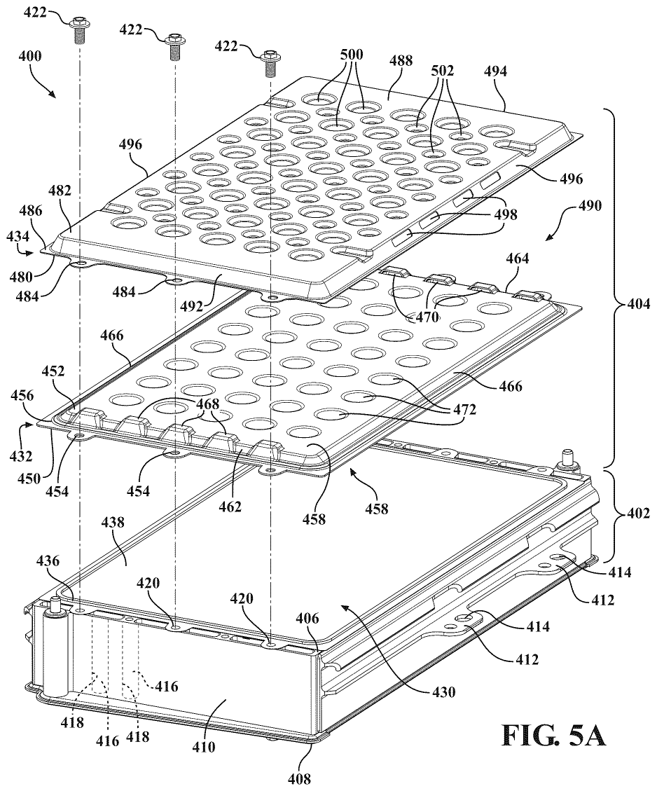

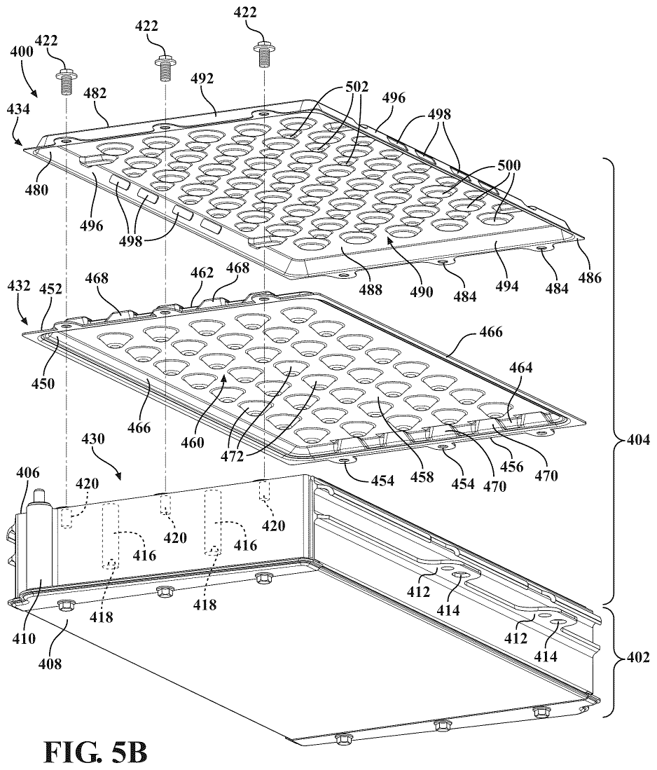

FIGS. 5A and 5B illustrate another illustrative configuration of a battery pack 400. This configuration is similar in many respects to the configurations of FIG. 1, FIGS. 2-3C, and FIGS. 4A-4B. Accordingly, the descriptions of the configurations are hereby incorporated into one another, and description of subject matter common to the configurations generally may not be repeated.

With reference to FIGS. 5A and 5B, an illustrative example of a battery pack 400 having a cell holder 402 and an expansion chamber 404 is provided. The cell holder 402 includes a first side 406 and a second side 408 spaced from the first side 406. The cell holder 402 has a perimeter wall 410 extending between the first side 406 and the second side 408 and including one or more mounting flanges 412 that are configured to facilitate coupling or otherwise attaching the battery pack 400 to a vehicle (e.g., the vehicle 10). The mounting flanges 412 can have openings 414 that are configured to receive a fastener (not shown), for example. The cell holder 402 can be configured to receive one or more battery modules (not shown) and/or one or more battery cells 416. For instance, the cell holder 402 can include a potting structure (e.g., a honeycomb holder) that has one or more slots 418 that extend between the first side 406 and the second side 408 and are configured to receive the one or more battery cells 416. The battery cells 416 are cylindrical battery cells in the present example, however, the principles of the present disclosure equally apply to battery cells that have another shape (e.g., prismatic battery cells). The cell holder 402 includes one or more holes 420 that are configured to receive one or more fasteners 422 for securing the expansion chamber 404 to the cell holder 402.

The expansion chamber 404 includes a thermal barrier layer 430, a first or inner chamber 432, and a second or outer chamber 434. With reference to FIGS. 5A and 5B, the thermal barrier layer 430 is coupled to the cell holder 402. More particularly, the thermal barrier layer 430 includes a bottom side 436 that is coupled to or otherwise attached to the first side 406 of the cell holder 402 and covers one or more of the slots 418. The thermal barrier layer 430 includes a top side 438 that is disposed on a side opposite of the bottom side 436 and facing away from the first side 406 of the cell holder 402.

The inner chamber 432 is coupled to the first side 406 of the cell holder 402. The inner chamber 432 includes a first side 450 and a second side 452 disposed on a side opposite of the first side 450. The inner chamber 432 includes one or more fastener through holes 454 arranged adjacent to a perimeter 456 of the inner chamber 432. At least some of the fastener through holes 454 correspond with the holes 420 of the cell holder 402 and are configured to receive the fasteners 422 for securing the inner chamber 432 to the cell holder 402.

The first side 450 includes a first cavity 458 that corresponds with the thermal barrier layer 430 and defines a first fluid conduit 460. The first cavity 458 includes a first end 462 and a second end 464 spaced from the first end 462 and side walls 466 extending from the first end 462 to the second end 464. The first end 462 includes one or more first outlets 468 and the second end 464 includes one or more second outlets 470. The first and second outlets 468, 470 are configured to allow gasses and particulate matter to escape the first fluid conduit 460.

The first cavity 458 can further include one or more first depressions 472 that extend into the first fluid conduit 460 and engage with the top side 438 of the thermal barrier layer 430. The first depressions 472 can be arranged in a pattern (e.g., rows) or scattered. The first depressions 472 can be desirable for increasing turbulence within the first fluid conduit 460 and enhancing cooling of gases and particulate matter during a thermal propagation event.

The outer chamber 434 is coupled to second side 452 of the inner chamber 432 and the cell holder 402. The outer chamber 434 includes a first side 480 and a second side 482 disposed on a side opposite of the first side 480. The first side 480 contacts and faces the second side 452 of the inner chamber 432. The outer chamber 434 includes one or more fastener through holes 484 arranged adjacent to a perimeter 486 of the outer chamber 434. At least some of the fastener through holes 484 correspond with the holes 420 of the cell holder 402 and are configured to receive the fasteners 422 for securing the outer chamber 434 to the cell holder 402.

The first side 480 includes a second cavity 488 that corresponds with the first cavity 458 of the inner chamber 432 and defines a second fluid conduit 490. The second cavity 488 includes a first end 492 and a second end 494 spaced from the first end 492 and side walls 496 extending from the first end 492 to the second end 494. The side walls 496 include one or more outlets 498 that are configured to allow gasses and particulate matter to escape the second fluid conduit 490.

The second cavity 488 can further include one or more first depressions 500 and one or more second depressions 502 that each extend into the first fluid conduit 460. The first depressions 500 are configured to correspond with the first depressions 472 of the first cavity and the second depressions are configured to engage with the second side 482 of the inner chamber 432. The first and second depressions 500, 502 of the second cavity 488 can be desirable for increasing turbulence within the second fluid conduit 490 and enhancing cooling of gases and particulate matter during a thermal propagation event.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery pack, comprising:
a cell holder having one or more slots;
one or more battery cells arranged in the cell holder;
a thermal barrier layer coupled to the cell holder and covering the one or more battery cells and the one or more slots;
a first chamber adjacent to the thermal barrier layer and coupled to the cell holder, the first chamber including one or more first outlets; and
a second chamber corresponding to the first chamber and coupled to the cell holder, the second chamber including one or more second outlets spaced from the first outlets of the first chamber.

2. The battery pack of claim 1, wherein the battery pack includes a first fluid conduit disposed between the first chamber and the thermal barrier layer.

3. The battery pack of claim 2, wherein the first fluid conduit extends between the one or more slots and the one or more first outlets of the first chamber.

4. The battery pack of claim 3, wherein the battery pack includes a second fluid conduit disposed between the first chamber and the second chamber.

5. The battery pack of claim 4, wherein the second fluid conduit extends between the one or more first outlets of the first chamber and the one or more second outlets of the second chamber.

6. The battery pack of claim 1, wherein the first chamber includes a first serpentine channel and the second chamber includes a second serpentine channel that corresponds with the first serpentine channel.

7. The battery pack of claim 6, wherein the first chamber includes a first serpentine pathway along the first serpentine channel and extending from the one or more battery cells to the one or more first outlets of the first chamber.

8. The battery pack of claim 7, wherein the second chamber includes a second serpentine pathway along the second serpentine channel and extending from the one or more first outlets of the first chamber to the one or more second outlets of the second chamber.

9. The battery pack of claim 8, wherein the second serpentine channel includes staggered fins extending into the second serpentine pathway.

10. The battery pack of claim 8, wherein the second serpentine channel includes ribs extending into the second serpentine pathway.

11. A vehicle, comprising:
a vehicle body extending between a first end and a second end;
an electric motor coupled to the vehicle body; and
a battery pack coupled to the vehicle body and communicatively coupled to the electric motor, the battery pack comprising:
a cell holder including one or more slots,
one or more battery cells arranged in the one or more slots,
a thermal barrier layer coupled to the cell holder and covering the one or more battery cells and the one or more slots,
a first chamber adjacent to the thermal barrier layer and coupled to the cell holder, the first chamber including one or more first outlets, and
a second chamber corresponding to the first chamber and coupled to the cell holder, the second chamber including one or more second outlets spaced from the first outlets of the first chamber.

12. The vehicle of claim 11, wherein the battery pack includes a first fluid conduit disposed between the first chamber and the thermal barrier layer.

13. The vehicle of claim 12, wherein the first fluid conduit extends between the one or more slots and the one or more first outlets of the first chamber toward the first chamber.

14. The vehicle of claim 13, wherein the battery pack includes a second fluid conduit disposed between the first chamber and the second chamber toward the first chamber.

15. The vehicle of claim 14, wherein the second fluid conduit extends between one or more first openings and the one or more second outlets of the second chamber.

16. The vehicle of claim 11, wherein the first chamber includes a first serpentine channel and the second chamber includes a second serpentine channel that corresponds with the first serpentine channel.

17. The vehicle of claim 16, wherein the first chamber includes a first serpentine pathway along the first serpentine channel and extending from the one or more battery cells to the one or more first outlets of the first chamber.

18. The vehicle of claim 17, wherein the second chamber includes a second serpentine pathway along the second serpentine channel and extending from the one or more first outlets of the first chamber to the one or more second outlets of the second chamber.

19. The vehicle of claim 18, wherein the second serpentine channel includes staggered fins extending into the second serpentine pathway toward the first chamber.

20. The vehicle of claim 19, wherein the second serpentine channel includes ribs extending into the second serpentine pathway toward the first chamber.
